(19) United States
(12) Patent Application Publication
(10) Pub. No.: US 2011/0028209 A1
(43) Pub. Date: Feb. 3, 2011

(54) CONTROLLING CONTENT ACCESS

(75) Inventors: Duoc Nguyen, Newcastle, WA (US); Gerald E. Weiler, II, Sammamish, WA (US); Ling Tony Chen, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/512,921

(22) Filed: Jul. 30, 2009

(51) Int. Cl. A63F 9/24; G06F 21/22

(52) U.S. Cl. 463/29; 726/30; 713/176

(57) ABSTRACT

Embodiments related to controlling access to content are disclosed. In one disclosed embodiment, a computing system comprising an application program further includes a device identification code identifying the computing system. The computing system further includes a content manager configured to control access by the application program to a content package, and the content manager is further configured to update a device audit list of the content package upon allowing the application program to modify the content package. The content manager is further configured to digitally sign the content package with a private key of the computing system after the application program modifies the content package.

### BACKGROUND

Computing systems such as gaming consoles may be used for gaming and/or entertainment purposes. For example, a gaming console may display an electronic game on a display device, and a user may play the game by interacting with the gaming console via an input device such as a game controller. Examples of types of electronic games include, but are not limited to, educational games, action-adventure games, first-person shooter games, role-playing games, strategy games, and the like.

In some cases, a player may make unauthorized modifications to exploit features of a game so as to receive an unfair advantage. Such modifications may include increasing user-related resources in the game such as weapons, health, ammunition, achievements, etc.

### SUMMARY

Accordingly, various embodiments related to the control of access to content are provided. For example, one embodiment provides a computing system comprising mass storage, memory, a processor coupled to the memory and an application program stored in mass storage, where the application program includes instructions executable by the processor to receive an input from an input device and to send an output to a display device. The computing system further includes a device identification code stored on the computing system, where the device identification code identifies the computing system. The computing system further includes a content package stored in mass storage, where the content package includes a device audit list identifying one or more computing systems that have modified the content package, and a private key stored on the computing system. The computing system further includes a content manager configured to control access by the application program to the content package. The content manager may be configured to update the device audit list upon allowing the application program to modify the content package, and may be further configured to digitally sign the content package with the private key after the application program modifies the content package.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of an embodiment of a computing system in accordance with the present disclosure.

FIG. 2 is a flowchart illustrating an example embodiment of a method of modifying a content package.

FIG. 3 is a flowchart illustrating an example embodiment of a method of controlling access to a content package.

FIG. 4 is a flowchart illustrating an example embodiment of a method of uploading a device audit list to a network-accessible server.

### DETAILED DESCRIPTION

Computing systems such as gaming consoles may be used for gaming and/or entertainment purposes. It is not uncommon for a player to make unauthorized modifications to exploit features of a game so as to receive an unfair advantage. Such modifications may include, but are not limited to, increasing user-related resources in the game such as weapons, health, ammunition, achievements, etc. Such modifications may be made on another computing system, for example a personal computer external to the gaming console, and may be therefore difficult to track. Therefore, various embodiments are disclosed herein that may allow computing systems making unauthorized modifications to be tracked, and may further control access to unauthorized modifications, as described in more detail as follows.

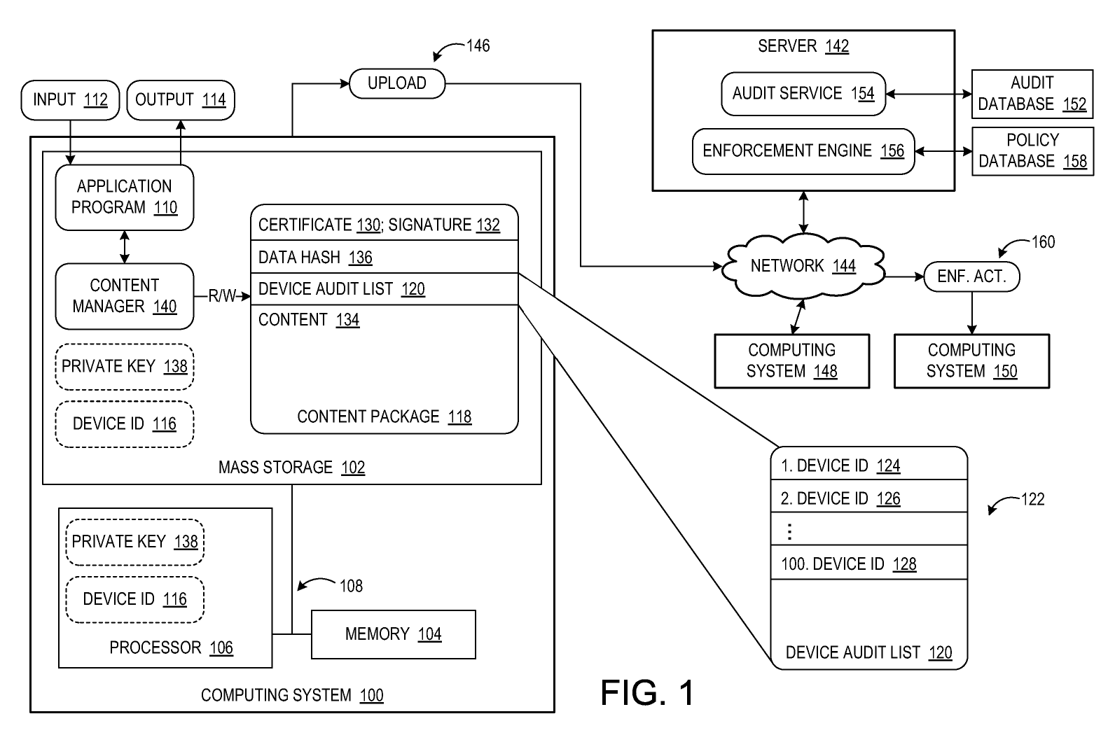

FIG. 1 shows a computing system 100 (e.g., a client computing system), including mass storage 102, memory 104 and a processor 106 coupled to memory 104. As an example, memory 104 and processor 106 may be coupled to mass storage 102 via a bus, as indicated at 108.

Mass storage 102 may include any suitable type or types of machine-readable storage such as hard disks, floppy disks, flash memory, optical discs, magneto-optical discs, read-only memory (ROM), etc. In some cases mass storage 102 may include devices with removable and/or non-removable media.

Computing system 100 may further include an application program 110 stored in mass storage. Application program 110 may include instructions executable by processor 106 to receive an input 112 from an input device and to send an output 114 to a display device. As a nonlimiting example, computing system 100 may be a gaming console. In such a case, application program 110 may be an electronic game, such that a user may play the game by interacting with the gaming console via an input device such as a game controller. For example, the game controller may send input 112 to application program 110, and application program 110 may then send output 114 to a display device such as a TV, HDTV, computer monitor or other such display device.

Computing system 100 may further include a device identification code 116 that identifies the computing system 100. In some embodiments, device identification code 116 may be stored in mass storage 102. In other embodiments, device identification code 116 may be, for example, fused into processor 106. Further, in some embodiments, device identification code 116 may uniquely identify computing system 100. As a nonlimiting example, computing system 100 may have a device identification corresponding to the hardware, and device identification code 116 may be a machine-readable representation of such identification. As a nonlimiting example, a device identification may be stamped into the hardware of the computing system, and device identification code 116 may be a 5-byte value representing that device identification.

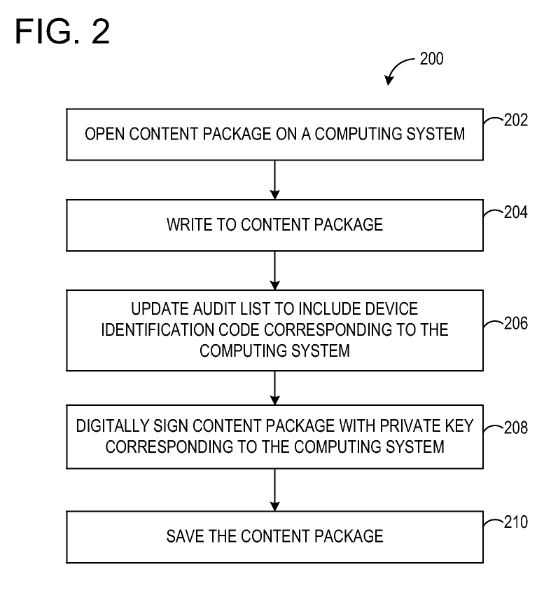

Computing system 100 may further include a content package 118 stored in mass storage 102. Content package 118 may be a file containing content and metadata. For example, content package 118 may be a container for text, images, data files, and the like. In some cases, content package 118 may include a header portion and a content portion. Content package 118 may be embedded within another content package, such as a content package representing a user profile corresponding to a user of computing system 100. Content package 118 may include a device audit list 120 identifying one or more computing systems that have modified content package 118. For example, when a computing system such as computing system 100 or any other such computing system modifies content package 118 (e.g. to award an achievement to a player), the identification code of the computing system making the modification (i.e., a modifying device identification code) is added to audit list 120. Such a process is described in more detail hereafter with reference to FIG. 2.

As an example, device audit list 120 may be a list of device identification codes as shown in an expanded view at 122. In some embodiments, device audit list may be configured to track a finite number (N) of device identification codes (e.g., N=100), such as is depicted at the expanded view at 122 where device audit list 120 includes device identification codes 124, 126 and 128, among others. Further, device audit list 120 may be ordered based on when the modification occurred, such that the most recent entry is a first entry in device audit list 120. In the depicted example, device identification code 124 may be the most recent entry in device audit list 120.

A content package such as content package 118 may be accessed during execution of application program 110. For example, in the context of the gaming example introduced above, content package 118 may be accessed during typical game play. In some cases, content package 118 may be accessed for reading purposes, to obtain information such as user information from a user profile corresponding to a user. In other cases, content package 118 may be accessed for modification purposes, to record information about a user. A nonlimiting example of such modifications may include recording achievement points (i.e., achievements) earned by a user during game play.

Content package 118 may further include a digital certificate 130 and digital signature 132 corresponding to the computing system that has most recently signed content package 118. Digital certificate 130 may have been issued to that computing system by a trusted authority, and digital certificate 130 may include a public key corresponding to a private key used by that computing system to generate digital signature 132. Further, digital certificate 130 may also include a device identification code corresponding to the computing system that has most recently signed the content package 118 (i.e., a signing device identification code).

Content package 118 may further include content 134. Content 134 may be, for example, content related to a user profile for a user of computing system 100. As such, modifications to content package 118 may include modifications to content 134.

Content package 118 may further include a data hash 136. Data hash 136 may have been generated by a computing system having most recently modified content package 118. For example, data hash 136 may be a hash of device audit list 120 and content 134 of content package 118. Further, upon creating data hash 136, data hash 136 may have then been used by that computing system as input for generating digital signature 132. Accordingly, in some embodiments, content package 118 may be further configured to store digital certificate 130, digital signature 132 and data hash 136 in a header portion of content package 118. In some embodiments, the header may also include device audit list 120.

Returning to computing system 100, computing system 100 may further include a private key 138 used for digital encryption such as digital signatures. In some cases, private key 138 may be stored in mass storage 102. In other cases, private key 138 may be, for example, fused into processor 106. Computing system 100 may further include a content manager 140 configured to control access by application program 110 to content package 118. Content manager 140 may also be configured to update device audit list 120 upon allowing application program 110 to modify content package 118. For example, content manager 140 may be configured to add device identification code 116 as a most recent entry to device audit list 120.

Content manager 140 may be further configured to digitally sign content package 118 with private key 138 after application program 110 modifies content package 118. For example, the content manager may be configured to digitally sign content package 118 by creating a data hash of device audit list 120 and content 134 of content package 118, and using the data hash as input for generating a digital signature.

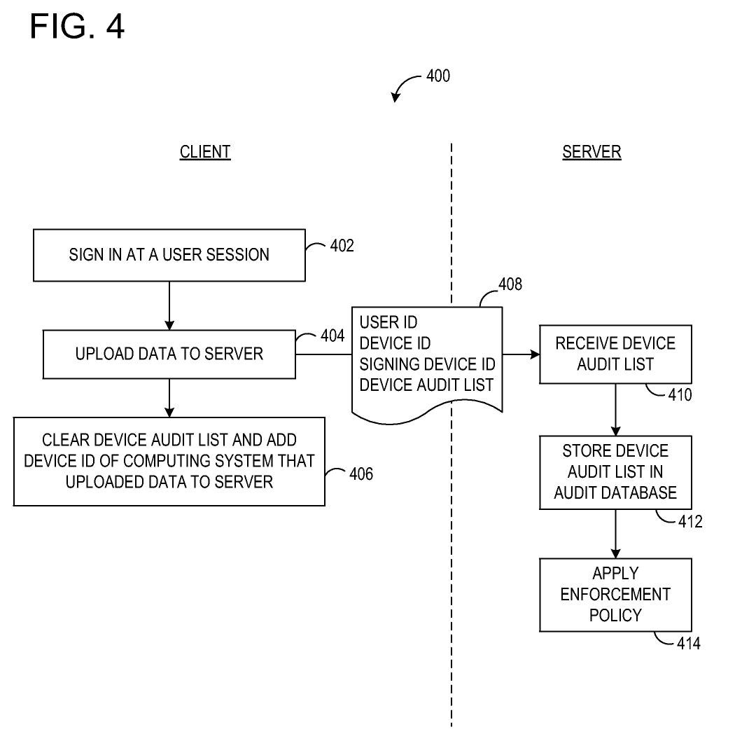

Content manager 140 may be further configured to upload data to a network-accessible server 142 via network 144. For example, computing system 100 may be configured to upload to network-accessible server 142 one or more of device audit list 120, device identification code 116, and a user identification code corresponding to a user of computing system 100, such as is depicted in FIG. 1 at 146. Uploading of such data to a network-accessible server is described in more detail hereafter with reference to FIG. 4.

Network-accessible server 142 may be configured to interact with a plurality of client computing systems, such as computing system 148 and computing system 150. For example, each of the plurality of such computing systems may be able to upload a device audit list from that computing system to the network-accessible server 142. In some embodiments, network-accessible server 142 may store received device audit lists in an audit database 152. Network-accessible server 142 may be further configured to include an audit service 154 configured to access audit database 152 for purposes of data mining, etc.

As such, network-accessible server 142 may be further configured to include an enforcement engine 156 configured to access a policy database 158 for purposes of creating enforcement actions based on one or more device audit lists received from one or more computing systems and actions performed by audit service 154. In some cases, such an enforcement action may then be sent to a computing system. As an example, at 160, FIG. 1 depicts network-accessible server 142 sending an enforcement action to computing system 150. Interactions between a computing system and a network-accessible server are described in more detail hereafter with reference to FIG. 4.

Although computing system 100 is described in the context of a gaming console, it can be appreciated that computing system 100 may be any such computing system configured to sign various resources in a way such that its signature identifies the hardware that did the alteration, i.e. a computing system having a private key.

Further, although modifications were described in the context of achievements made during game play, modifications may also include, but are not limited to, other such changes to user profile content such as user characteristics, avatar attributes, and the like.

As described above, a computing system such as a gaming console may read a content package during game play, and may further modify the content package to record, for example, an attribute related to a user's performance within the game (e.g., an achievement). FIG. 2 illustrates an example embodiment of a method 200 of modifying a content package.

At 202, method 200 may include opening the content package on the computing system (e.g., a gaming console). Upon opening the content package, at 204 method 200 may include writing to the content package. As an example use scenario, a user of a game may be awarded an achievement. In response, the achievement may be linked to the user by recording the achievement within the user's profile. The user's profile may be represented as a content package, such that writing to the content package may include, for example, modifying a portion of the content included within the content package.

At 206, method 200 may include updating the device audit list to include a device identification code corresponding to the computing system. For example, in the context of the gaming console introduced above, upon modifying the content package, the gaming console may then add to a device audit list (e.g., a console audit list) the device identification code (e.g., console identification code) corresponding to the console. As such, the console audit list serves as a record of consoles that have modified the content package, wherein the aforementioned addition to the console audit list is a most recent entry in the console audit list.

At 208, method 200 may include digitally signing the content package with a private key corresponding to the computing system. Continuing with the context of the gaming example, upon updating the console audit list, the gaming console may then encrypt the content package by digitally signing the content package with a private key that corresponds to the gaming console. As described above, a console may do so by hashing the console audit list and content to create a data hash which is then used as input to generate a digital signature. The digital signature may then be added to the content package, for example, in a header of the content package. Accordingly, digitally signing the content package may also add a digital certificate to the content package, for example in a header of the content package. Such a digital certificate may include the console identification code and a public key corresponding to the console's private key. At 210, method 200 may include saving the content package.

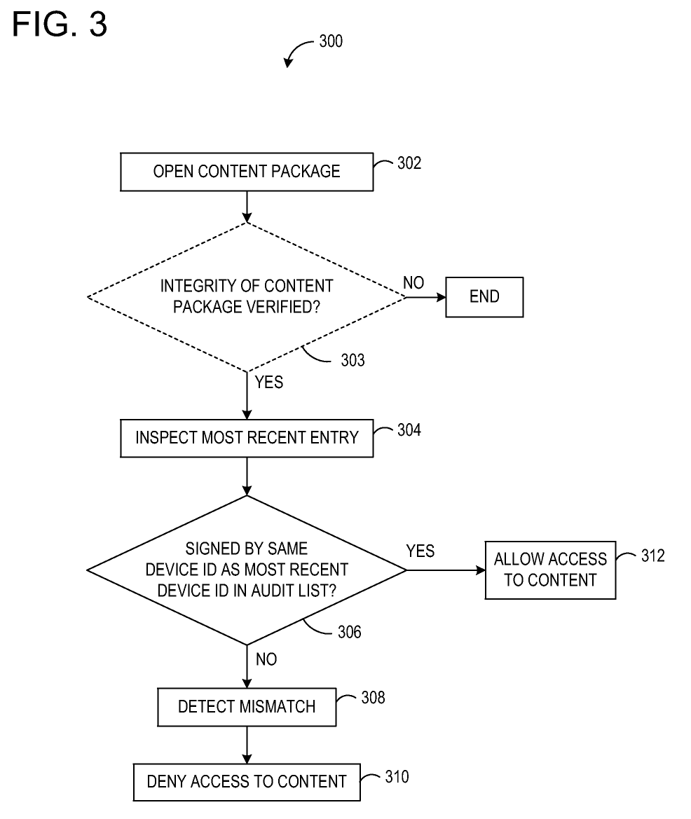

Therefore, content packages as described herein may provide content security, if a private key has not been hacked, as well as content reliability. For example, a data hash of the content package may be utilized to ensure that when a content package is opened that it has not been modified in an unauthorized manner. In other words, upon opening a content package, a hash of the contents may be examined to determine if the hash matches an expected hash, and if the hash does not match, then the file may be determined to be corrupt or have been tampered with. Content access may be further controlled based on an audit list, as described in more detail with reference to FIG. 3.

FIG. 3 illustrates an embodiment of a method 300 of controlling access to a content package on a computing system, such as a gaming console. At 302, method 300 includes opening a content package. Such a content package may include content, and a device audit list (e.g., a console audit list) identifying one or more computing systems (e.g., gaming consoles) that have modified the content package. The content package may further include a digital certificate comprising a signing device identification code (e.g., signing console identification code). The signing console identification code corresponds to a gaming console that digitally signed the content package.

At 303, method 300 optionally includes verifying the integrity of the content package. This may be done in any suitable manner, such as by examining a hash of the contents to determine if the hash matches an expected hash. If the hash does not match, then the content package may be determined to be corrupt or have been tampered with. However, if the hash does match, then the integrity of the content package is verified.

At 304, method 300 includes inspecting a most recent entry of the console audit list. The most recent entry includes a modifying device identification code (e.g., a modifying console identification code), corresponding to a gaming console that most recently modified the content package.

At 306, method 300 includes comparing the signing console identification code to the modifying console identification code. If the signing console identification code is different than the modifying console identification code, then at 308 method 300 includes detecting a mismatch. As such, upon detecting a mismatch, at 310 method 300 may include denying access to the content.

However, if it is determined at 306 that the signing console identification code is equivalent to the modifying console identification code, then at 312 method 300 includes allowing access to the content. Allowing access to the content may include allowing the console to read the content package (e.g., access to user-related information during game play that is stored in the content package), allowing the console to modify the content package (e.g., to record an achievement earned during game play), allowing the console to proceed with typical game play, etc.

It can be appreciated that a method of controlling access to a content package, such as method 300, may be used in various use scenarios upon opening a content package. For example, in the context of method 200 described above, upon opening the content package at 202, method 300 may be utilized to verify the content package is valid and has not been tampered with. If it is determined that the content package is valid, then access to the content is granted. Accordingly method 200 may then proceed to 204.

In other words, a possible use scenario may include, prior to opening the content package, receiving a player award and upon allowing access to the content, modifying the content package to include the player award. As an example, the computing system may be a gaming console and the player award may be a game achievement earned during game play. Returning to the use scenario, upon modifying the content package, the gaming console may update the console audit list to include a console identification code as a most recent entry in the console audit list, where the console identification code identifies the console. As described above, the console audit list may be an ordered list such that the most recent entry is a first entry in the console audit list. The use scenario may further include, upon updating the console audit list, digitally signing the content package with a private key stored on the console. Such digital signing of the content package may include creating a data hash of the console audit list and the content, and using the data hash as input for generating a digital signature.

As described above, in some embodiments, a computing system may be further configured to upload data to a network-accessible server. For example, in terms of the gaming context introduced thus far, the computing system may be a gaming console and the network-accessible server may be an online gaming service. As an example, FIG. 4 shows an embodiment of a method 400 of uploading data to a server.

At 402, method 400 includes signing in at a user session. For example, this may include a login to an initial user session such as a gaming session, or a login at a subsequent gaming session after ending a previous gaming session.

At 404, method 400 next includes uploading the console audit list to the online gaming service. In addition to the console audit list, a console may upload additional data as depicted at 408, such as a user identification code identifying a user of the console. The console may further upload a console identification code identifying the console which is uploading the data to the server. Further, in some embodiments, the console may further upload a signing console identification code identifying a console that most recently signed the content package having the console audit list.

At 406, upon uploading the data to the online gaming service, method 400 may include clearing entries of the console audit list stored on the console and adding to the console audit list the console identification code corresponding to the console that uploaded the data to the online gaming service.

It can be appreciated that various users who desire to augment user profiles with unearned achievements, etc. may develop software that emulates modification and signing of a content package. Accordingly, in some embodiments, method 400 may be utilized in a use scenario where upon receiving the console audit list as depicted at 410, an online gaming service may then store the console audit list, for example, in an audit database. The online gaming service may be configured to access the audit database for purposes of data mining, etc., for example, via an audit service. The online gaming service may be further configured to access a policy database, for example via an enforcement engine, for purposes of creating enforcement actions based on one or more device audit lists received from one or more consoles. Thus, in some embodiments, online gaming service may apply an enforcement policy as depicted at 414.

Applying an enforcement policy may include, but is not limited to, sending an enforcement action to one or more consoles. Such a console may be the console that uploaded the data (i.e., the console corresponding to the console identification code). As another example, such a console may be the console that most recently signed the content package (i.e., the console corresponding to the signing console identification code). As another example, such a console may be any of the consoles that have modified the content package (i.e., the console corresponding to a modifying console identification code appearing in the console audit list).

For example, the online gaming service may determine that a legitimate console identification code has been compromised and utilized illegitimately by a hacker via hacking tools external to a console (e.g., PC hacking tools) to award achievements. As such, that compromised console identification code may have been used to modify a content package (and therefore is a modifying console identification code) and/or may have been used to sign a content package (and therefore is a signing console identification code). Further, if the compromised console identification code was made available to several hackers, then the online gaming service may determine, for example upon data mining, that a modifying console identification code and/or signing console identification code appears frequently in one or more audit lists. As such, the console identified by the modifying console identification code and/or the signing console identification code may be the console receiving the enforcement action.

Thus, a computing system such as a gaming console may be configured to receive an enforcement action based on the device audit list it submitted to the online gaming service, or to receive an enforcement action based on a device audit list submitted to the online gaming service by another console. As nonlimiting examples, an enforcement action may include the online gaming service banning a user, a user account, a console, etc. from utilizing the services provided by the online gaming service.

Therefore, whereas previous solutions could not track “offline” modifications to a content package, the systems and methods as disclosed herein allow such modifications to a content package to be tracked via device identification codes. Further, such tracking via a device audit list also allows for controlling access of content stored in content packages. Further, in some embodiments, the embodiments as disclosed herein may also allow for a network-accessible server to accordingly take enforcement actions.

It will be appreciated that the order in which the steps of methods 200, 300 and 400 are described are merely illustrative, and the steps may be performed in another suitable order. Further, the modules in which they are performed may be located on one computing device or on several distributed computing devices.

Further, it will be appreciated that the computing devices described herein may be any suitable computing device configured to execute the programs described herein. For example, the computing devices may be a mainframe computer, personal computer, laptop computer, portable data assistant (PDA), computer-enabled wireless telephone, networked computing device, or other suitable computing device, and may be connected to each other via computer networks, such as the Internet. These computing devices typically include a processor and associated volatile and non-volatile memory devices, and are configured to execute programs stored in non-volatile memory devices using portions of volatile memory and the processor.

As used herein, the term “program” refers to software or firmware components that may be executed by, or utilized by, one or more computing devices described herein, and is meant to encompass individual or groups of executable files, data files, libraries, drivers, scripts, database records, etc. Thus, the methods described herein can be performed by running a program that is stored on a computer-readable medium. It will be appreciated that computer-readable media may be provided having program instructions stored thereon, which upon execution by a computing device, cause the computing device to execute the methods described above and cause operation of the systems described above. Computer-readable media may include a memory device such as random-access memory (RAM), read-only memory (ROM), a hard disk, a compact disc (CD), digital video disc (DVD), etc. Some or all of the modules described herein may be software modules or hardware components, such as memory devices.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A computing system comprising:
mass storage;
memory;
a processor coupled to the memory;
an application program stored in mass storage, the application program including instructions executable by the processor to receive an input from an input device and to send an output to a display device;
a device identification code stored on the computing system, the device identification code identifying the computing system;
a content package stored in mass storage, the content package including a device audit list identifying one or more computing systems that have modified the content package;
a private key stored on the computing system; and
a content manager configured to control access by the application program to the content package, the content manager further configured to update the device audit list upon allowing the application program to modify the content package and the content manager further configured to digitally sign the content package with the private key after the application program modifies the content package.

2. The computing system of claim 1, wherein the computing system is further configured to upload to a network-accessible server one or more of the device audit list, the device identification code, and a user identification code corresponding to a user of the computing system.

3. The computing system of claim 1, wherein the content manager is configured to digitally sign the content package by creating a data hash of the device audit list and content of the content package, and using the data hash as input for generating a digital signature.

4. The computing system of claim 1, wherein the computing system is a gaming console.

5. A method of controlling access to a content package on a computing system, the method including:
opening the content package, the content package including content, a device audit list identifying one or more computing systems that have modified the content package, and a digital certificate including a signing device identification code corresponding to a computing system that digitally signed the content package;
inspecting a most recent entry of the device audit list, the most recent entry including a modifying device identification code corresponding to a computing system that most recently modified the content package;
comparing the signing device identification code to the modifying device identification code; and
if the signing device identification code is different than the modifying device identification code, then denying access to the content.

6. The method of claim 5, further comprising upon a login at a subsequent user session, uploading the device audit list to a network-accessible server.

7. The method of claim 6, further comprising uploading to the network-accessible server the signing device identification code, a device identification code identifying the computing system, and a user identification code corresponding to a user of the computing system.

8. The method of claim 7, further comprising, upon uploading the device audit list to the network-accessible server, clearing a plurality of entries of the device audit list stored on the computing system and adding the device identification code to the device audit list stored on the computing system.

9. The method of claim 6, wherein the computing system is further configured to receive an enforcement action from the network-accessible server based on the device audit list.

10. The method of claim 6, wherein the computing system is a gaming console and wherein the network-accessible server is an online gaming service.

11. The method of claim 5, further comprising, if the signing device identification code is equivalent to the modifying device identification code, then allowing access to the content.

12. The method of claim 11, further comprising, prior to opening the content package, receiving a player award, and upon allowing access to the content, modifying the content package to include the player award.

13. The method of claim 12, wherein the computing system is a gaming console and wherein the player award is a game achievement earned during game play.

14. The method of claim 12, further comprising, upon modifying the content package, updating the device audit list to include a device identification code as a most recent entry in the device audit list, the device identification code identifying the computing system.

15. The method of claim 14, wherein the device audit list is an ordered list such that the most recent entry is a first entry in the device audit list.

16. The method of claim 14, further comprising, upon updating the device audit list, digitally signing the content package with a private key stored on the computing system.

17. The method of claim 16, wherein digitally signing the content package includes creating a data hash of the device audit list and the content, and using the data hash as input for generating a digital signature.

18. A method of controlling access to a content package on a client gaming console, the method including:
opening the content package, the content package including content, a console audit list identifying one or more gaming consoles that have modified the content package, and a digital certificate including a signing console identification code corresponding to a gaming console that digitally signed the content package;
inspecting a most recent entry of the console audit list, the most recent entry including a modifying console identification code corresponding to a gaming console that most recently modified the content package;
comparing the signing console identification code to the modifying console identification code;
if the signing console identification code is equivalent to the modifying console identification code, then allowing access to the content;
if the signing console identification code is different than the modifying console identification code, then denying access to the content; and
uploading to a network-accessible gaming service at a next gaming session of the client gaming console, the console audit list, the signing console identification code, a console identification code identifying the client gaming console, and a user identification code corresponding to a user of the client gaming console.

19. The method of claim 18, further comprising, upon uploading to the network-accessible gaming service, clearing a plurality of entries of the console audit list stored on the client gaming console and adding the console identification code to the console audit list stored on the client gaming console.

20. The method of claim 18, further comprising, upon allow allowing access to the content, modifying the content package, updating the console audit list to include the console identification code as a most recent entry in the console audit list, and digitally signing the content package with a private key stored on the client gaming console.
